(19) United States
(12) Patent Application Publication
(10) Pub. No.: US 2016/0046073 A1
(43) Pub. Date: Feb. 18, 2016

(54) 3D PRINTER

(71) Applicant: Empire Technology Development LLC, Wilmington, DE (US)

(72) Inventor: Noam HADAS, Tel-Aviv (IL)

(21) Appl. No.: 14/462,317

(22) Filed: Aug. 18, 2014

(51) Int. Cl. B29C 67/00; B29C 47/30; B29C 47/12

(52) U.S. Cl. CPC B29C 67/0085; B29C 67/0055; B29C 47/122; B29C 47/124; B29C 47/30; B33Y 10/00

(57) ABSTRACT

In some examples, a three-dimensional (3D) printer nozzle may include a receive portion configured to receive a molten material from a material channel. The nozzle may further include an emission end opposite the receive portion. The emission end may include multiple holes that are each configured to receive the molten material and to emit the molten material. The nozzle may also include a rotation mechanism coupled to the emission end and configured to enable rotation of the nozzle about a tube. The tube may at least partially define the material channel.

### BACKGROUND

Unless otherwise indicated herein, the materials described herein are not prior art to the claims in the present application and are not admitted to be prior art by inclusion in this section.

Three-dimensional (3D) printers may be used to create objects of any number of different shapes and sizes. As such, their use is becoming more and more ubiquitous. However, the 3D printing process may be fairly time consuming, in which a tradeoff may exist between speed and high resolution and/or speed and accuracy. The limitation on production speed may contribute to a substantial amount of cost associated with 3D printing. Additionally, the long printing process may expose operators to toxic fumes over a prolonged period of time.

### SUMMARY

Technologies described herein generally relate to 3D printing.

In some examples, a method to perform three-dimensional (3D) printing is described. The method may include guiding a molten material through a material channel toward a nozzle. The method may also include emitting the molten material through multiple holes of the nozzle. Further, the method may include rotating the nozzle during emission of the molten material through the holes.

In some examples, a device configured to perform 3D printing is described. The device may include a tube that at least partially defines a material channel. The material channel may be configured to guide a molten material. The device may also include a nozzle coupled to the tube. The nozzle may be configured to receive the molten material from the material channel and to rotate. The nozzle may include multiple holes that may each be configured to emit the molten material.

In some examples, a device configured to perform 3D printing is described. The device may include a tube that at least partially defines a material channel. The material channel may be configured to guide a molten material. The device may also include a heat element coupled to the tube and configured to heat the molten material in the material channel to a target temperature. Further, the device may include a screw disposed in the material channel and configured such that rotation with respect to the screw pressurizes the molten material in the material channel. Additionally, the device may include a nozzle coupled to the tube and configured to receive the pressurized molten material. The nozzle may be configured to receive the molten material from the material channel and to rotate. The nozzle may include multiple holes that may each be configured to emit the molten material.

In some examples, a 3D printer nozzle is described. The nozzle may include a receive portion configured to receive a molten material from a material channel. The nozzle may further include an emission end opposite the receive portion. The emission end may include multiple holes that are each configured to receive the molten material and to emit the molten material. The nozzle may also include a rotation mechanism coupled to the emission end and configured to enable rotation of the nozzle about a tube. The tube may at least partially define the material channel.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings. In the drawings:

FIG. 1A illustrates example components of a 3D printer configured to perform 3D printing;

FIG. 1B illustrates an isometric view of a nozzle of the 3D printer of FIG. 1A;

FIG. 1C illustrates an example embodiment of a printer where a size of holes where a molten material may be emitted may be adjusted;

FIG. 1D illustrates an example front-facing view of a gear of the printer of FIG. 1C;

FIG. 1E illustrates another example front-facing view of a gear of the printer of FIG. 1C;

FIG. 2A illustrates a cross-sectional view of example components of a 3D printer configured to perform 3D printing;

FIG. 2B illustrates an example embodiment of a screw coupled to a nozzle of the 3D printer of FIG. 2A;

FIG. 2C illustrates an example embodiment of a screw coupled to an inside wall of a tube of the 3D printer of FIG. 2A;

FIG. 2D illustrates an exploded view of the elements of FIG. 2C;

FIG. 3 illustrates example components of a 3D printer configured to perform 3D printing;

FIG. 4 illustrates a flow diagram of an example method of 3D printing; and

FIG. 5 is a block diagram illustrating an example computing device that is arranged to direct one or more operations of a 3D printer; all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, and devices that relate to three-dimensional (3D) printing. 3D printing may be used to create objects that may have any number of different shapes and sizes. During 3D printing, a nozzle of a 3D printer may emit a thread of a molten material (e.g., a molten polymer) and a corresponding print-head and platform may move in three dimensions with respect to each other while the thread is being emitted. This process may create any number of objects on a layer-by-layer basis.

The speed and accuracy in which a 3D printer may operate may be influenced by the viscosity and/or solidification rate of the molten material. For example, a target viscosity of the molten material may be such that the molten material is adequately thin to flow out of the nozzle at a sufficiently fast rate to cover and bond to a previous layer. However, if the molten material is too thin, the material may sag, the dimensions of the printed object may be wrong, and/or bubbles and voids may form and/or other defect(s) may occur. The target viscosity may also be such that the molten material is sufficiently thick such that the material may hold its shape and dimensions until it cools and solidifies. However, if the molten material is too thick, the material may not flow well and may adversely affect printing speeds, or the dimensions of the plastic thread may be wrong, which may, create errors in final part dimensions. Further, the faster the molten material solidifies, the faster the printing speeds of the 3D printer may be obtained. However, the solidifying time of the molten material may be related to the temperature of the molten material, in which the lower the temperature, the faster the molten material may solidify. However, lower temperatures of the molten material may also correspond to a thicker viscosity of the molten material.

A “target viscosity” referred to herein may include any viscosity that is within a viscosity range that achieves specific 3D printing goals of a particular 3D printing application. As such, the target viscosity may vary by different applications and situations. Further, the target viscosity may include a range of viscosities that may be suitable for a 3D printing application.

In some embodiments, the target viscosity may be based on a printing speed of the 3D printer. For example, when the printing speed of the 3D printer is increased, the target viscosity may be decreased to achieve a target amount of coverage. In comparison, when the printing speed of the 3D printer is decreased, the target viscosity may be increased to achieve the target amount of coverage. In some embodiments, the printing speeds of the 3D printer may vary during the printing process of an object such that the target viscosity may vary.

Briefly stated and as described in detail below, one or more components of a 3D printer may be configured such that a target viscosity of the molten material may be achieved while also allowing for faster solidification of the molten material. For example, the molten material may exhibit properties of a non-Newtonian fluid in which the viscosity of the molten material may decrease as an agitating or shearing force may act on the molten material. Therefore, according to one or more embodiments of the present disclosure, one or more components of the 3D printer may be configured to decrease the viscosity of the molten material by increasing shearing forces that may be applied to the molten material. As such, the temperature of the molten material may be lowered while also obtaining a target viscosity of the molten material, which may allow for the molten material to solidify more quickly than with other 3D printing techniques. The faster solidifying time may allow for quicker 3D printing.

In some embodiments and as detailed below, a nozzle of the 3D printer may be configured to increase the shearing forces on the molten material to obtain the target viscosity. In these or other embodiments, a pressure element of the 3D printer may be configured to increase a pressure of the molten material with respect to the nozzle such that the shearing forces may be increased. Additionally or alternatively, an agitating element of the 3D printer may be configured to apply additional shearing forces to the molten material.

Reference is now made to the drawings.

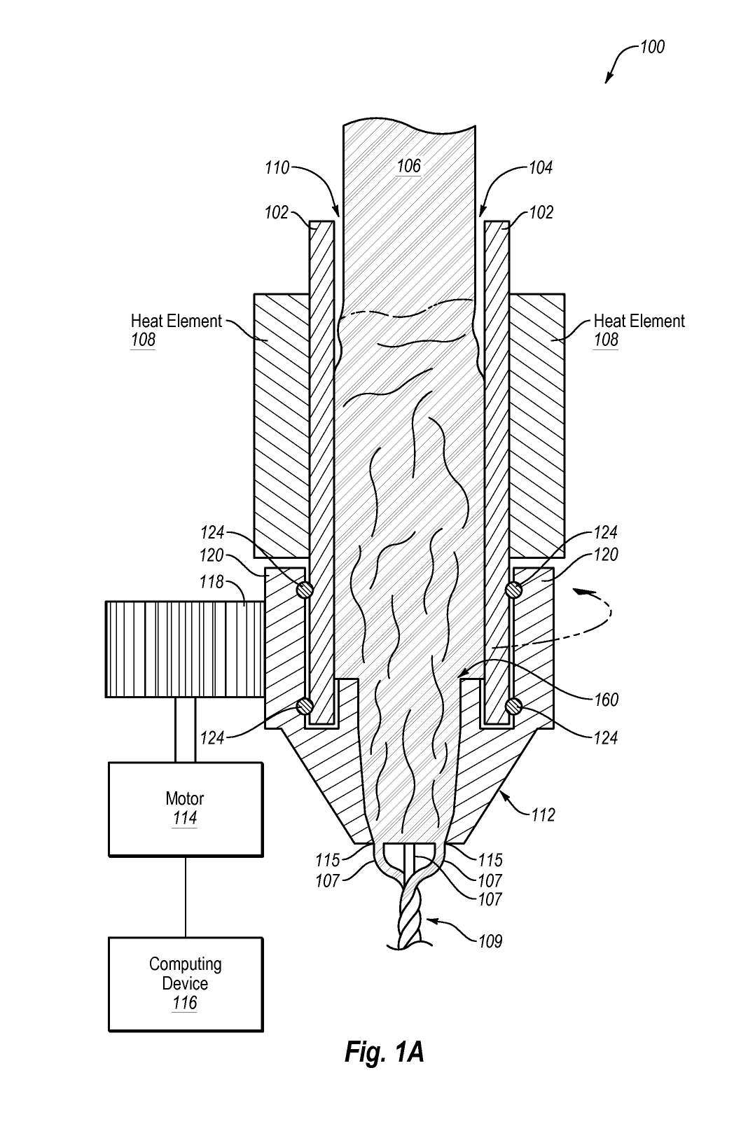

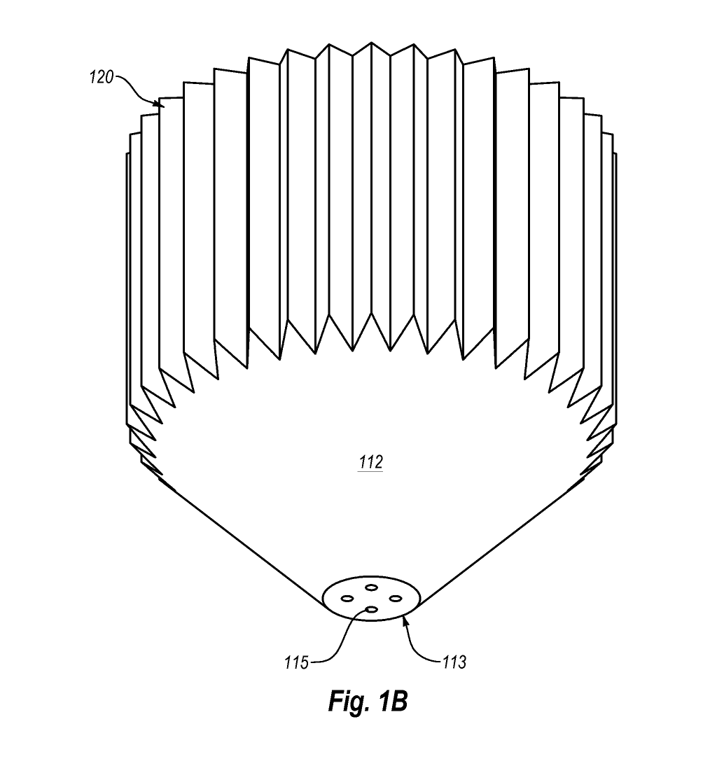

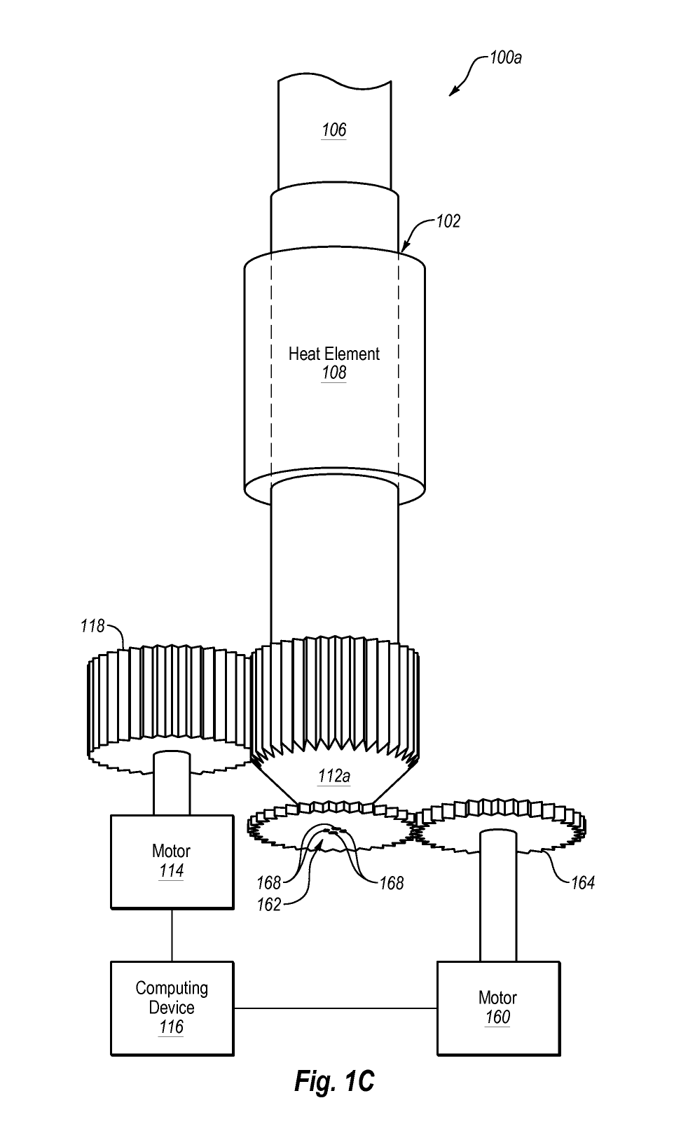

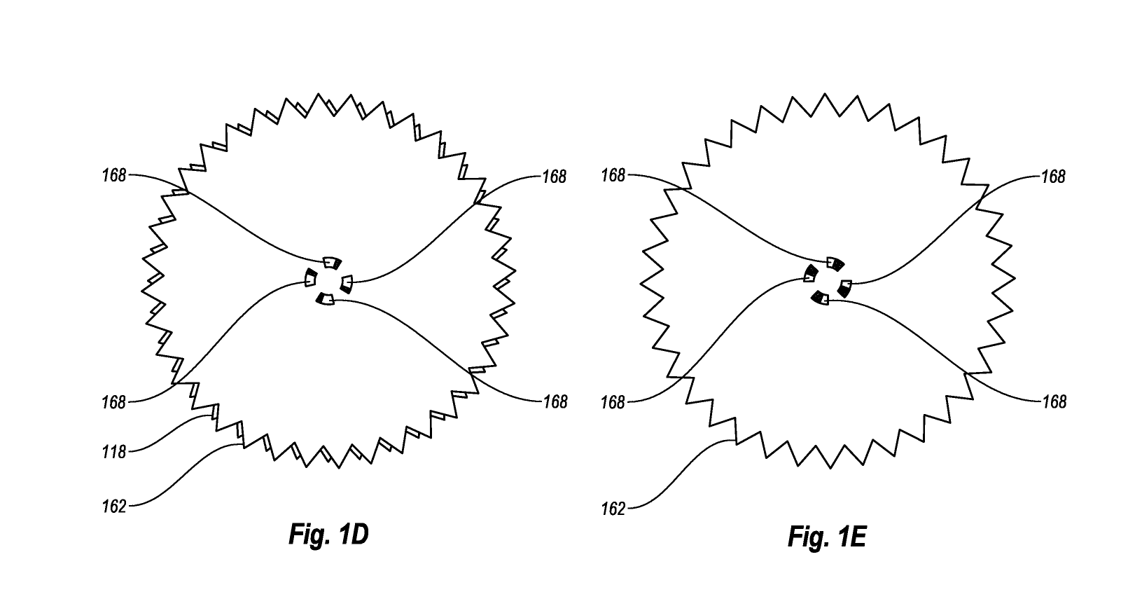

FIG. 1A illustrates a cross-sectional view of example components of a 3D printer 100 (referred to hereinafter as the “printer 100”) configured to perform 3D printing, arranged in accordance with at least some embodiments described herein. The printer 100 may include a tube 102, a heat element 108, and a nozzle 112.

The tube 102 may include any suitable device or apparatus that is configured to receive and guide a material 106. In some embodiments, the tube 102 may at least partially define a material channel 104 (referred to hereinafter as the “channel 104”) that may be configured to guide the material 106. For example, in some embodiments, the tube 102 may include a hollow portion that may constitute the channel 104. Therefore, in some embodiments, the channel 104 may be at least partially enclosed by the tube 102. Although the term “tube” may connote a cylindrical shape, the tube 102 may include any suitable shape (e.g., rectangular, triangular, conical, elliptical, etc.) that may at least partially define the channel 104.

The channel 104 may be configured to receive the material 106 at a receive end 110 of the channel 104. In the illustrated example, the material 106 may be received as a solid filament at the receive end 110. However, the material 106 may also be fed into the receive end 110 as granules. Further, in some embodiments, the material 106 may be fed into the tube while in a molten state instead of a solid state. The material 106 may include any suitable thermoplastic compound and/or other material(s) or combination(s) thereof that may be used for 3D printing. For example, in some embodiments, the material 106 may include a polymer. Further, the material 106 may exhibit non-Newtonian properties where a viscosity of the material 106 when molten may decrease when shearing forces are applied to the material 106 when molten. The channel 104 may be configured to guide the material 106 toward the heat element 108.

The heat element 108 may be coupled to the tube 102. The heat element 108 may be configured to apply heat to the tube 102. The tube 102 may be configured such that the heat may be transferred to the channel 104 and consequently to the material 106. For example, in some embodiments, the tube 102 may include a metal wall with an outside portion that may be in contact with the heat element 108 and an inside portion that may constitute a wall of the channel 104. Therefore, the heat from the heat element 108 may transfer from the outside portion of the metal wall to the inside portion of the metal wall such that the channel 104 and the material 106 disposed in the channel 104 may be heated.

In some embodiments, the heat element 108 may be configured to heat the channel 104 such that the material 106 may transition from a solid state to a molten state. The molten state of the material 106 may include any state where the material 106 takes on properties of and acts like a liquid or semi-solid. As such, the molten state may include when the material 106 is just beginning to melt and is a relatively thick liquid (e.g., a liquid with a relatively high viscosity) and the molten state may include when the material 106 is substantially melted and a relatively thin liquid (e.g., a liquid with a relatively low viscosity). The material 106 may be referred to herein as the “molten material 106” when in the molten state.

The heat element 108 may be configured to heat the molten material 106 such that a temperature of the molten material 106 may be at a target temperature. In some embodiments, such as illustrated in FIG. 1, the heat element 108 may both melt the material 106 into the molten state and heat the molten material 106 to the target temperature. In other embodiments, the material 106 may already be in a molten state upon reaching the heat element 108 and the heat element 108 may be configured to heat or cool the molten material 106 to the target temperature.

A “target temperature” referred to herein may include any temperature that is within a temperature range that achieves specific 3D printing goals of a particular 3D printing application and material used. As such, the target temperature may vary by different applications and situations. Further, the target temperature may include a range of temperatures that may be suitable for a 3D printing application.

In some embodiments, the target temperature may be based on a target viscosity of the molten material 106 when the molten material 106 is emitted out of the nozzle 112. As indicated above, viscosity of the molten material 106 may be based on the temperature of the molten material 106 and the amount of shearing forces that may be applied to the molten material 106. Therefore, the target temperature may also be based on the amount of shearing forces that may be applied to the molten material 106. For example, when the amount of shearing forces is relatively high, the target temperature may be lower to achieve the target viscosity than when the amount of shearing forces is relatively low. Further, as also indicated above, the target viscosity may be based on the printing speeds of the printer 100. Therefore, the target temperature may also be based on the printing speeds in some embodiments.

The nozzle 112 may be coupled to the tube 102 and may be configured to receive the molten material 106 from the channel 104 and to emit the molten material 106. The nozzle 112 may be configured to receive the molten material 106 at a receive portion 160 of the nozzle 112. Further, the nozzle 112 may include multiple holes 115 at an emission end 113 that may be opposite to or distal from the receive portion 160. At least some of the holes 115 may be configured to each emit the molten material 106 that is received at the receive portion 160.

In comparison, some other types of 3D printers may typically emit molten material via a single hole. In some embodiments, the collective cross-sectional area of the holes 115 may be approximately equal to, or equal to, the cross-sectional area of a single hole of a nozzle that may correspond to such other types of 3D printers. Therefore, the volume of molten material 106 that may be emitted from the holes 115 at a given time may be approximately the same as that which may be emitted at a given time from the single hole of such other types of 3D printers. In other embodiments, the cross-sectional area of the holes 115 may be less than or greater than that of the single hole of such other types of 3D printers. The aggregate of the cross-sectional area of the holes 115 may vary according to a particular 3D printing application.

The multiple holes 115 may cause more of the molten material 106 to come in contact with edges of the holes 115 while being emitted from the nozzle 112 than if a single, larger hole were present. The extra contact with the edges may increase shearing forces that may be exerted on the molten material 106 as it is emitted from the nozzle 112. Therefore, the multiple holes 115 may reduce the viscosity of the molten material 106 as compared to when a single hole is used. As such, the target temperature of the molten material 106 may be reduced to achieve a viscosity that is at the target viscosity as compared to when a single hole is used. FIG. 1B illustrates an isometric view of the nozzle 112 to further illustrate the holes 115 at the emission end 113, according to at least one embodiment described herein. Although, FIG. 1B specifically illustrates four holes 115, the nozzle 112 may include any number of holes 115.

Additionally, the manner in which the holes 115 may be configured and/or formed may vary. For example, in some embodiments, the holes 115 may be formed as individual holes in the nozzle 112, as illustrated. As another example, in some embodiments, the holes 115 may be formed by a net or net-like object that may be placed over one or more larger holes of the nozzle 112. In particular, in some embodiments, the nozzle 112 may include a single hole that may have a net with multiple holes placed over it such that the molten material 106 may be emitted from multiple holes instead of a single hole.

In some embodiments, the amount of shearing forces that may be applied by the holes 115 may be based on how small the holes 115 may be such that the size of the holes 115 may affect the viscosity of the molten material 106. Therefore, in some embodiments, the holes 115 may be sized according to the target viscosity and/or the target temperature of the molten material 106. In these or other embodiments, the holes 115 may be configured such that their size may be adjusted such that the viscosity of the molten material 106 may be varied also.

For example, as mentioned above, in some embodiments, the target viscosity may be based on a printing speed of the printer 100 such that a target size of the holes 115 may be based on the printing speed. In particular, as mentioned above, when the printing speed of the printer 100 is increased, the target viscosity may be decreased to achieve a target amount of coverage. Therefore, to decrease the target viscosity with respect to an increased printing speed, the target hole size may be decreased. In comparison, when the printing speed of the printer 100 is decreased, the target viscosity may be increased to achieve the target amount of coverage. Therefore, to increase the target viscosity with respect to a decreased printing speed, the target hole size may be increased.

FIGS. 1C-1E, illustrate an example embodiment of a printer 100a where a size of holes of a nozzle 112a may be adjusted. The printer 100a and the nozzle 112a illustrate example implementations of the printer 100 and the nozzle 112, respectively, of FIGS. 1A and 1B. In the illustrated example, the printer 100a may include the tube 102, the heat element 108, the computing device 116, the motor 114 and the gear 118.

In the illustrated example, the nozzle 112a may include a gear 162 that may be coupled to an emission end of the nozzle 112a. The gear 162 may be coupled to the emission end such that the gear 162 may substantially cover the holes of the nozzle 112a (e.g., the holes 115 described above). Further, the gear 162 may include openings 168 and may be configured such that the openings 168 may move in and out of alignment with the holes as the gear 162 rotates. Therefore, depending on the rotational position of the gear 162 with respect to the holes, the effective size of the holes may be adjusted based on how aligned the openings 168 are with the holes.

For example, FIGS. 1D and 1E illustrate example front-facing views of the gear 162 with rotational positions where the openings 168 may have differing alignments with respect to the holes of the nozzle 112a. As illustrated in FIGS. 1D and 1E, the effective size of the holes may be different based on the differing alignments. As such, the gear 162 may act as a hole adjustment mechanism for the printer 100a based on its rotational position with respect to the holes.

In some embodiments, the rotational position of the gear 162 may be controlled by the computing device 116. For example, in some embodiments, a motor 160 may be coupled to a gear 164 such that the gear 164 may rotate in response to rotation of the motor 160. The motor 160 may also be communicatively coupled to the computing device 116. The motor 160 may be configured to rotate in response to a control signal that may be generated by the computing device 116. The motor 160 may include any suitable motor that may be configured to rotate in response to the control signal. For example, in some embodiments, the motor 160 may include a stepper motor in which the motor 160 may be configured to incrementally rotate according to the control signal.

The gear 164 and the gear 162 may be configured such that, in response to rotation of the gear 164 by the motor 160, the gear 164 may engage or otherwise interact with the gear 162 to rotate the gear 162. Therefore, the computing device 116 may be configured to adjust a rotational position of the gear 162 by controlling rotation of the motor 160. As such, the computing device 116 may be configured to adjust the effective size of the holes of the nozzle 112a by directing an amount of rotation of the motor 160.

Returning to FIG. 1A, in some embodiments, each of the holes 115 may be configured to emit a thread 107 of the molten material 106. In some embodiments, the printer 100 may be configured such that the individual threads 107 may be wrapped into a single larger thread 109. The wrapping of the threads 107 into the thread 109 may reduce fuzzy or inaccurate printing that may occur from having multiple threads laid down at the same time during the printing process.

In some embodiments, the nozzle 112 may be configured to rotate such that the threads 107 may be wrapped into the thread 109 when the threads 107 are emitted from the holes 115. In some embodiments, the nozzle 112 may be configured to rotate about the tube 102. For example, in the illustrated example, the nozzle 112 may include a bearing channel configured to receive one or more ball bearings 124 (referred to hereinafter as “bearings 124”). Further, the bearings 124 may be disposed between the bearing channel and the tube 102 such that the nozzle 112 may rotate (clockwise or counterclockwise) about the tube 102 via the bearings 124. The nozzle 112 may accordingly include a rotation mechanism coupled to the emission end 113 and configured to enable rotation of the nozzle 112 about the tube 102 such that the threads 107 may be wrapped into the thread 109.

Further, the nozzle 112 may include a gear portion 120. Another view of the gear portion 120 is illustrated in FIG. 1B, in which the gear portion includes “teeth” along its periphery. The gear portion 120 may be coupled to a gear 118 of the printer 100 and the gear 118 in turn may be coupled to a motor 114 of the printer 100. The gear 118 may be coupled to the motor 114 such that the motor 114 may rotate the gear 118 when the motor 114 is activated. Further, the gear portion 120 and the gear 118 may be configured such that, in response to rotation of the gear 118 by the motor 114, the gear 118 may engage or otherwise interact with the gear portion 120 to rotate the nozzle 112 about the tube 102. Accordingly, the gear portion 120 may be included with and part of the rotation mechanism of the nozzle 112.

In some embodiments, the motor 114 may be coupled to a computing device 116. The computing device 116 may be configured to drive or control the driving of the motor 114, such that the computing device 116 may be configured to control the timing of when the motor 114 rotates the gear 118. In these or other embodiments, the computing device 116 may also be configured to adjust or otherwise control the speed of the motor 114 such that the rotational speed of the nozzle 112 may be varied.

Accordingly, the printer 100 may be configured to achieve a target viscosity of the molten material 106 at a lower temperature than other types of 3D printers. As such, the printing speed of the printer 100 may be increased as compared to such other types of 3D printers. Modifications, additions, or omissions may be made to the printer 100 without departing from the scope of the present disclosure. For example, the printer 100 may include any number of other components that may provide and support the operation of the printer 100. Additionally, in some embodiments, the nozzle 112 and the tube 102 may be configured to rotate together instead of the nozzle 112 rotating about the tube 102 as illustrated and described above.

Further, in some embodiments, the printer 100 may include one or more additional components that may increase the pressure of the molten material 106 as the molten material 106 is emitted from the holes 115. The increased pressure may increase the shearing forces on the molten material 106 that may be applied to the molten material 106 by the holes 115. Therefore, the increased pressure may also be used to achieve the target viscosity at an even lower temperature. Further, in some instances, the increased pressure may allow for a larger number of smaller holes 115 to achieve the target viscosity at lower temperatures.

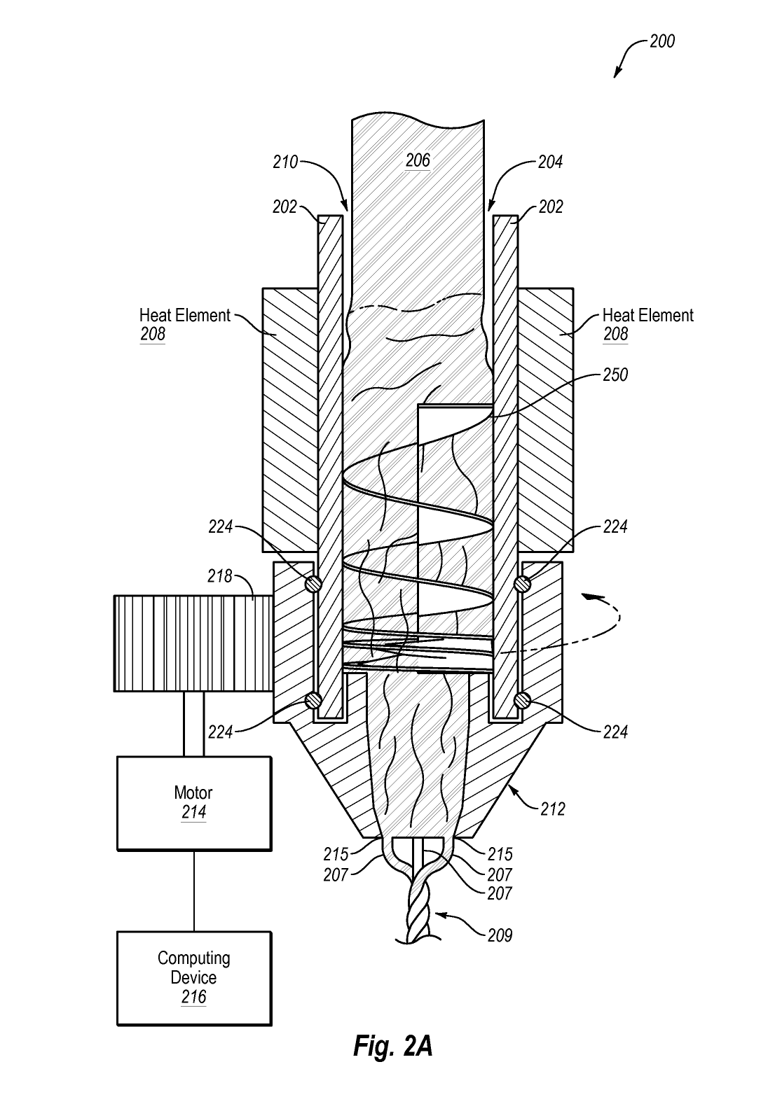

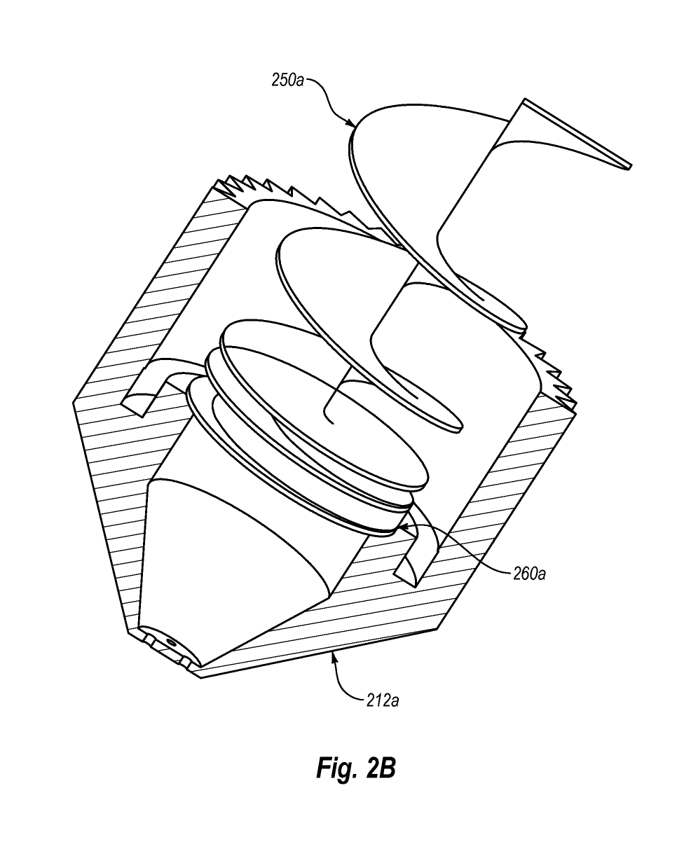

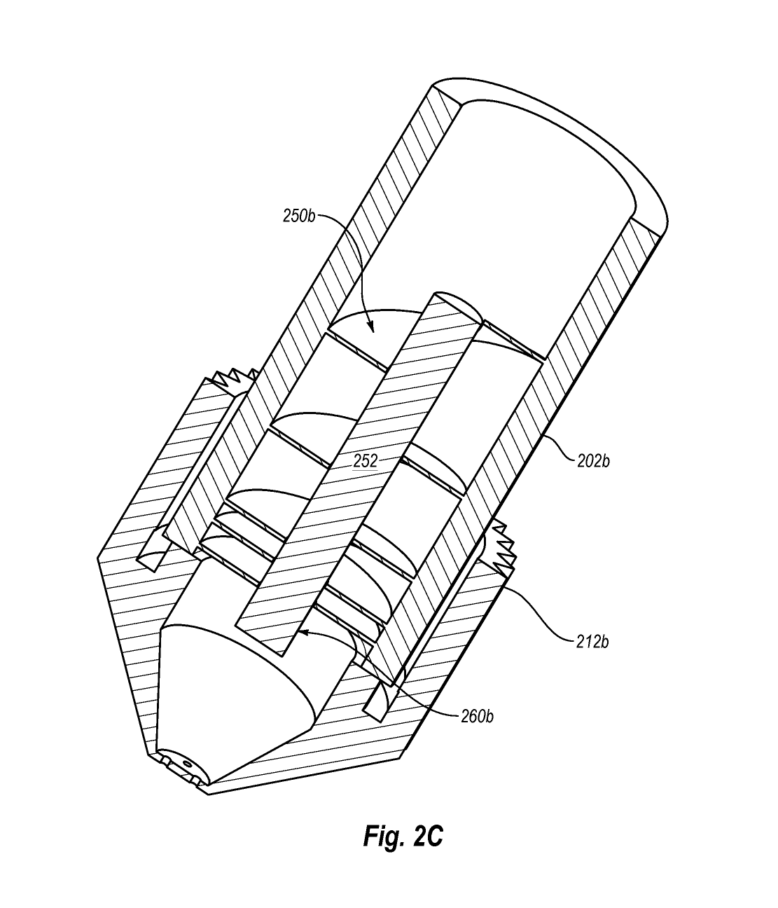

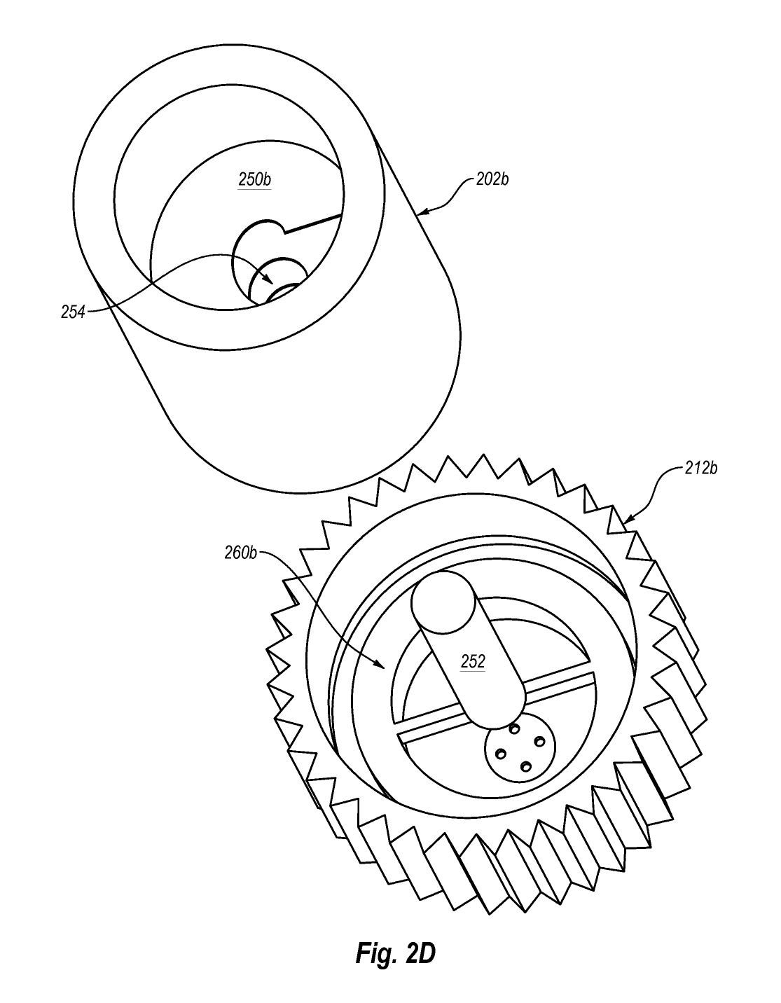

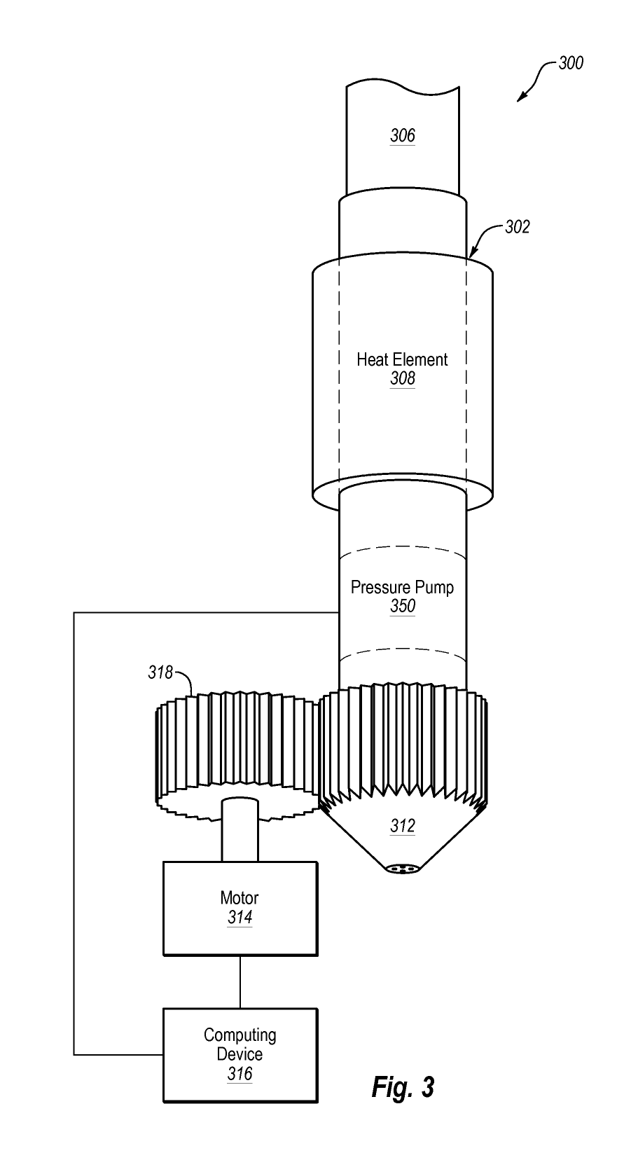

In these or other embodiments, the printer 100 may include one or more components that may apply shearing forces to the molten material 106 in the channel 104. Consequently, the applied shearing forces in the channel 104 may also be used to achieve the target viscosity at an even lower temperature. FIGS. 2A-2D and 3 describe example 3D printers (and/or components thereof) configured to increase a pressure of a molten material that may be emitted by a nozzle that includes multiple holes. Additionally, the 3D printer of FIGS. 2A-2D may also provide shearing forces to a molten material within a corresponding material channel.

FIG. 2A illustrates a cross-sectional view of example components of a 3D printer 200 (referred to hereinafter as the “printer 200”) configured to perform 3D printing, arranged in accordance with at least some embodiments described herein. The printer 200 may include a tube 202, a material channel 204, a heat element 208, a nozzle 212, a motor 214, a gear 218, ball bearings 224, and a computing device 216, that may be analogous to the tube 102, the material channel 104, the heat element 108, the nozzle 112, the motor 114, the gear 118, the ball bearings 124, and the computing device 116, respectively, of FIG. 1A. As such, the printer 200 may be configured to deposit a material 206 in a molten state to form an object as described above. The material 206 may be analogous to the material 106 of FIG. 1A. Additionally, similar to the material 106, the material 206 may be referred to as the “molten material 206” when the material 206 is in the molten state.

The printer 200 may also include a screw 250 that may be disposed inside the material channel 204. The screw 250 may include a screw step that may correspond to the distance between threads of the screw 250. In some embodiments (e.g., as illustrated in FIG. 2A), the screw 250 may be configured such that the screw step may decrease along a length of the screw 250 in a direction towards the nozzle 212. Therefore, the distance between the threads may be closer at or near the nozzle 212 than away from the nozzle 212. Other configurations for the screw step are possible.

The screw 250 may be configured such that a rotation may be performed about the screw 250. The rotation about the screw 250 may be any relative rotation between the screw 250 and another surface that may be in contact with the molten material 206 in the area of the material channel 204 where the screw 250 may be disposed.

For example, in some embodiments, the screw 250 may be coupled to the nozzle 212 such that the screw 250 may rotate along with rotation of the nozzle 212. In other embodiments, the screw 250 may be driven by a mechanism that is separate and independent from that which is configured to rotate the nozzle 212. Therefore, in these example embodiments, the screw 250 may rotate with respect to the inside wall of the tube 202. FIG. 2B illustrates an example embodiment of a screw 250a coupled to a nozzle 212a. The screw 250a and the nozzle 212a illustrate example implementations of the screw 250 and the nozzle 212, respectively, of FIG. 2A. In the illustrated example, the screw 250a may be coupled to a receive portion 260a of the nozzle 212a such that the screw 250a may rotate along with rotation of the nozzle 212a. The receive portion 260a of the nozzle 212a may be analogous to the receive portion 160 of the nozzle 112.

Returning to FIG. 2A, as another example, the screw 250 may be coupled to an inside wall of the tube 202 In these or other embodiments, the screw 250 may include a hole through the center in which a pin may be disposed. As such, the pin may be configured such that it may be in contact with the molten material 206. Further, the pin may be configured to rotate with respect to the screw 250 such that a relative rotation between the pin and the screw 250 may occur. In some embodiments, the pin may be coupled to the nozzle 212 such that the screw pin may rotate along with rotation of the nozzle 212. In other embodiments, the pin may be driven by a mechanism that is separate and independent from that which is configured to rotate the nozzle 212.

FIGS. 2C and 2D illustrate an example embodiment of a screw 250b coupled to an inside wall of a tube 202b. Further, in the illustrated example of FIGS. 2C and 2D, a pin 252 may be coupled to a receive portion 260b of a nozzle 212b. Therefore, the pin 252 may be configured to rotate with the nozzle 212b. Additionally, the pin 252 may be configured to be disposed in a hole 254 (labeled in FIG. 2D) as illustrated in FIG. 2C. Therefore, in response to rotation of the nozzle 212b, the pin 252 may rotate and may have a relative rotation with respect to the screw 250b. The screw 250b, the tube 202b, and the nozzle 212b illustrate example implementations of the screw 250, the tube 202, and the nozzle 212, respectively, of FIG. 2A. Further, the receive portion 260a of the nozzle 212a may be analogous to the receive portion 160 of the nozzle 112.

Returning to FIG. 2A, the relative rotation about the screw 250 may direct the molten material 206 along grooves in the screw 250 toward the nozzle 212. Further, the decreasing screw step may increase a pressure of the molten material 206 in the material channel 204 as the molten material 206 moves toward the nozzle 212. Therefore, the pressure of the molten material 206 as it is extruded from holes 215 of the nozzle 212 may be increased such that the screw 250 may act as a pressure element.

As indicated above, the increased pressure at the holes 215 of the nozzle 212 may increase the shearing forces that may be applied to the molten material 206 as it interacts with the holes 215, which may lower the viscosity of the molten material 206. In some embodiments, the screw 250 may be configured such that the pressure at the holes 215 of the nozzle 212 is at a target pressure. The target pressure may be based on one or more of a target temperature and target viscosity of the molten material 206 such that a target operation of the printer 200 may be achieved.

As mentioned above, in some embodiments, the target viscosity may be based on a printing speed of the printer 200 such that the target pressure may be based on the printing speed. For example, as mentioned above, when the printing speed of the printer 200 is increased, the target viscosity may be decreased to achieve a target amount of coverage. Therefore, to decrease the target viscosity with respect to an increased printing speed, the target pressure may be increased. In comparison, when the printing speed of the printer 200 is decreased, the target viscosity may be increased to achieve the target amount of coverage. Therefore, to increase the target viscosity with respect to a decreased printing speed, the target pressure may be decreased.

In some embodiments, the amount of pressure that may be generated by the screw 250 may be based on how fast the rotation with respect to the screw 250 may be. As such, in some embodiments (e.g., when the rotation with respect to the screw 250 corresponds to the rotation of the nozzle 212), the computing device 216 may be configured to adjust the rotational speed of the nozzle 212 to achieve the target pressure. In these or other embodiments, (e.g., when the rotation with respect to the screw 250 is independent of the rotation of the nozzle 212), the computing device 216 may be configured to direct the rotational speed with respect to the screw 250 via control of an independent mechanism that drives the rotation with respect to the screw 250.

As indicated above, in some instances, the printing speed of the printer 200 may vary during the printing process of an object such that the target viscosity and the target pressure may vary during the printing process. Therefore, in some embodiments, the computing device 216 may be configured to vary the pressure as the printing speed varies.

Further, in these or other embodiments, the target pressure may be based on the size of the holes 215. For example, an emission rate from the holes 215 may correspond to the size of the holes 215 and the amount of pressure, as well as the viscosity. Therefore, to obtain a target emission rate, the target pressure may be adjusted based on the size of the holes 215. In some embodiments, the size of the holes 215 may be dynamically changed as described above. Therefore, in some embodiments, the pressure may also be varied according to the changes in size of the holes 215.

Further, the relative rotation about the screw 250 may apply additional shearing forces to the molten material 206 in the material channel 204, which may also lower the viscosity of the molten material. As also indicated above, the lowering of the viscosity may allow for the temperature of the molten material to be reduced while also achieving a target viscosity of the molten material 206.

Accordingly, the printer 200 may be configured to achieve a target viscosity of the molten material 206 at a lower temperature than other types of 3D printers. As such, the printing speed of the printer 200 may be increased as compared to other types of 3D printers. Modifications, additions, or omissions may be made to the printer 200 without departing from the scope of the present disclosure. For example, the printer 200 may include any number of other components that may provide and support the operation of the printer 200.

FIG. 3 illustrates example components of a 3D printer 300 (referred to hereinafter as the “printer 300”) configured to perform 3D printing, arranged in accordance with at least some embodiments described herein. The printer 300 may include a tube 302 that may at least partially define a material channel (not expressly depicted in FIG. 3), a heat element 308, a nozzle 312, a motor 314, a gear 318, and a computing device 316, that may be analogous to the tube 102, the heat element 108, the nozzle 112, the motor 114, the gear 118, and the computing device 116, respectively, of FIG. 1A. As such, the printer 300 may be configured to deposit a material 306 in a molten state to form an object as described above. The material 306 may be analogous to the material 106 of FIG. 1A. Additionally, similar to the material 106, the material 306 may be referred to as the “molten material 306” when the material 306 is in the molten state.

In the illustrated embodiment, the heat element 308 may be configured to heat the material 306 into a molten state. In some embodiments, the heating element 308 may also be configured to heat the molten material 306 to a target temperature. After the heating element 308 has heated the material 306 into the molten state, the molten material 306 may be directed to a pressure pump 350 that may be coupled to and disposed in the tube 302.

The pressure pump 350 may include any suitable system, apparatus, or device configured to provide a pumping action that may pressurize the molten material 306 such that the pressure pump 350 may act as a pressure element of the printer 300. In some embodiments, the pressure pump 350 may include a heat element configured to maintain the temperature of the molten material 306 at the target temperature and/or to bring the temperature to the target temperature. The tube 302 may be configured to direct the pressurized molten material 306 toward the nozzle 312 for emission from the multiple holes of the nozzle 312. As detailed above, the pressure of the molten material 306 that may be provided by the pressure pump 350 may increase the shearing forces that may be applied to the molten material 306 as it is emitted from the nozzle 312, which may decrease the viscosity of the molten material 306. In some embodiments, the computing device 316 may be configured to direct or otherwise control the operations of the pressure pump 350 such that the pressure that may be generated by the pressure pump 350 may be adjusted. Therefore, the pressure may be adjusted according to printing speeds in some embodiments, as described above.

Accordingly, the printer 300 may be configured to achieve a target viscosity of the molten material 306 at a lower temperature than conventional 3D printers. As such, the printing speed of the printer 300 may be increased as compared to other types of 3D printers. Modifications, additions, or omissions may be made to the printer 300 without departing from the scope of the present disclosure. For example, the printer 300 may include any number of other components that may provide and support the operation of the printer 300. As another example, the tube 302 may include any number of tubes or receptacles that may be configured to receive and/or guide the material 306 in a molten or solid state.

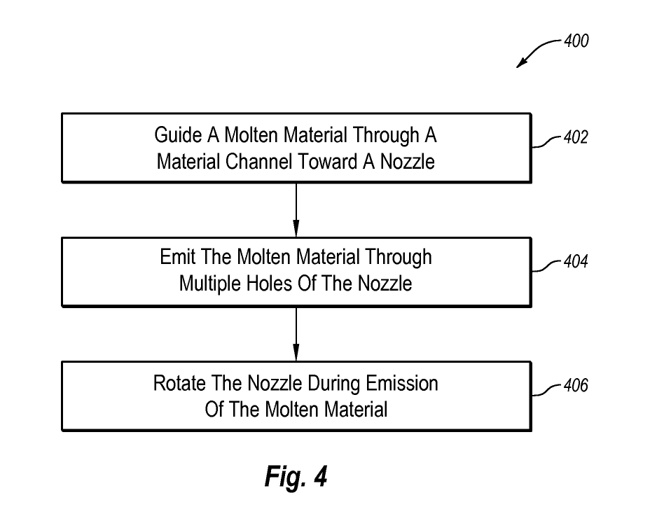

FIG. 4 illustrates a flow diagram of an example method 400 of 3D printing, arranged in accordance with at least some embodiments described herein. The method 400 may be performed in whole or in part by one or more of the printers 100, 200, 300, described above, or any other suitable system or apparatus. The method 400 includes various operations, functions, or actions as illustrated by one or more of blocks 402, 404, and/or 406.

For this and other processes and methods disclosed herein, the operations performed in the processes and methods may be implemented in differing order. Furthermore, the depicted operations are only provided as examples, and some of the operations may be optional, combined into fewer operations, supplemented with other operations, or expanded into additional operations without detracting from the essence of the disclosed embodiments. The method 400 may begin at block 402.

In block 402 (“Guide a Molten Material Through A Material Channel Toward A Nozzle”), a molten material may be guided toward a nozzle through a material channel. Block 402 may be followed by block 404.

In block 404 (“Emit The Molten Material Through Multiple Holes Of The Nozzle”), the molten material may be emitted through multiple holes in the nozzle. In some embodiments, the molten material may be emitted as a thread from each of the holes. Block 404 may be followed by block 406.

In block 406 (“Rotate The Nozzle During Emission Of The Molten Material”), the nozzle may be rotated during emission of the molten material through the holes. The rotation may be such that the individual threads that may be emitted from each of the holes may be wrapped into a single thread.

Modifications, additions, or omissions may be made to the method 400 without departing from the scope of the present disclosure. For example, the method 400 may include pressurizing the molten material in the material channel. In some embodiments, the pressurizing may include performing a rotation with respect to a screw that is disposed inside of the material channel. Additionally or alternatively, the pressurizing may be performed by a pressure pump. In some embodiments, pressurizing the molten material may include pressurizing the molten material to a pressure that is based on one or more of a target temperature of the molten material, a printing speed of the 3D printer, and a target viscosity of the molten material.

In these and other embodiments, the method 400 may include heating the molten material to a target temperature. In some embodiments, the target temperature of the molten material may be based on one or more of a printing speed of the 3D printer, a pressure of the molten material at the nozzle, the specific material used and a target viscosity of the molten material upon emission from the of holes.

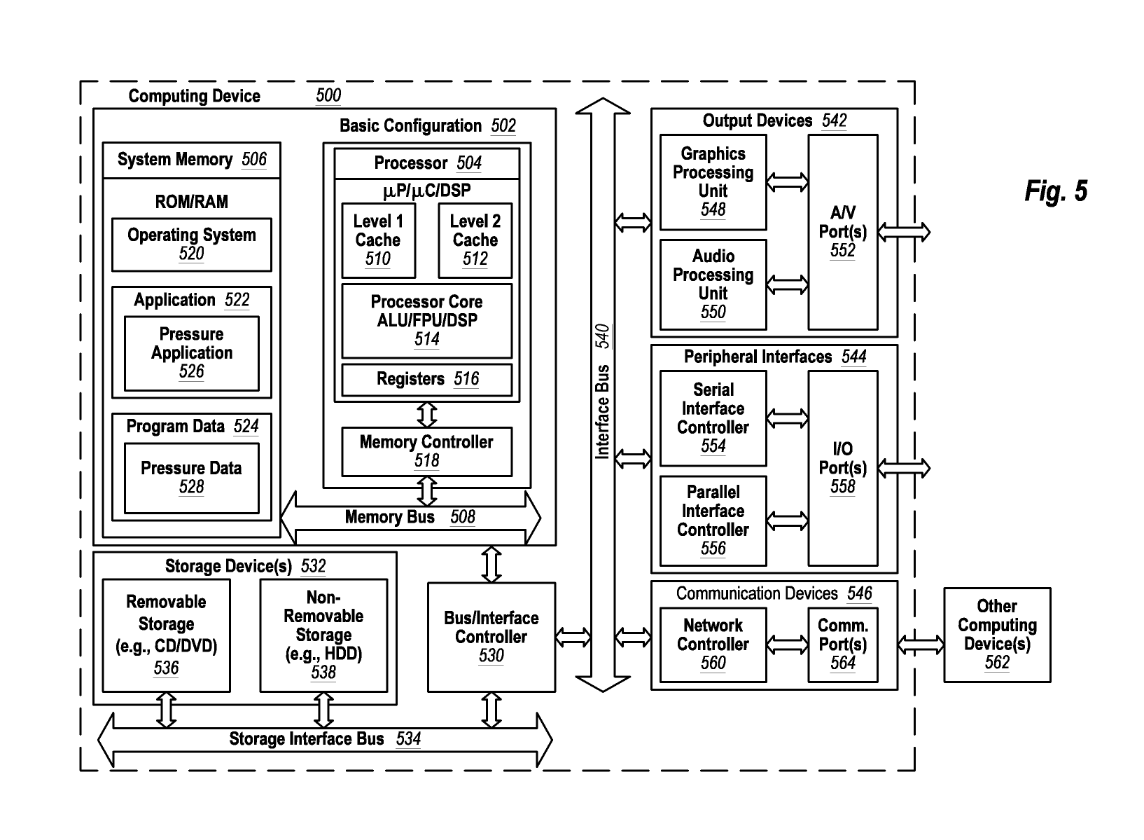

FIG. 5 is a block diagram illustrating an example computing device 500 that is arranged to direct one or more operations of a 3D printer, arranged in accordance with at least some embodiments described herein. The computing device 500 may represent an example configuration of the computing devices 116, 216, and 316 described above. In a very basic configuration 502, the computing device 500 typically includes one or more processors 504 and a system memory 506. A memory bus 508 may be used for communicating between the processor 504 and the system memory 506.

Depending on the desired configuration, the processor 504 may be of any type including, but not limited to, a microprocessor (μP), a microcontroller (μC), a digital signal processor (DSP), or any combination thereof. The processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, the system memory 506 may be of any type including, but not limited to, volatile memory (such as RAM), non-volatile memory (such as ROM, flash memory, etc.), or any other type of non-transitory computer-readable medium and any combination thereof. The system memory 506 may include an operating system 520, one or more applications 522, and program data 524. The application 522 may include a pressure application 526 that may include instructions (executable by a processor such as the processor 504) pertaining to adjusting the pressure of the molten material and/or otherwise controlling operation of the various components of a 3D printer as described above. Program data 524 may include pressure data 528 that may be useful for determining and obtaining a target pressure and/or other printer-related data, as is described herein. In some embodiments, the application 522 may be arranged to operate with program data 524 on operating system 520 such that the pressure adjustment and other printer-related operations may be performed. This described basic configuration 502 is illustrated in FIG. 5 by those components within the inner dashed line.

The computing device 500 may have additional features or functionality, and additional interfaces to facilitate communications between the basic configuration 502 and any required devices and interfaces. For example, a bus/interface controller 530 may be used to facilitate communications between the basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and hard-disk drives (HDDs), optical disk drives such as compact disk (CD) drives or digital versatile disk (DVDs) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

System memory 506, removable storage devices 536, and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., output devices 542, peripheral interfaces 544, and communication devices 546) to the basic configuration 502 via the bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media,” as used herein, may include both storage media and communication media.

The computing device 500 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. The computing device 500 may also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The present disclosure is not limited to particular methods, reagents, compounds, compositions, or biological systems, which can, of course, vary. The terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). Additionally, virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, the disclosure is also thereby described in terms of any individual member or subgroup of members of the Markush group.

For any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. Also all language such as “up to,” “at least,” and the like may include the number recited and refer to ranges which can be subsequently broken down into sub ranges as discussed above. Finally, a range may include each individual member. Thus, for example, a group having 1-3 cells may refer to groups having 1, 2, or 3 cells. Similarly, a group having 1-5 cells refers to groups having 1, 2, 3, 4, or 5 cells, and so forth.

From the foregoing, various embodiments of the present disclosure have been described herein for purposes of illustration, and various modifications may be made without departing from the scope and spirit of the present disclosure. Accordingly, the various embodiments disclosed herein are not intended to be limiting, with the true scope and spirit being indicated by the following claims.

What is claimed is:

1. A device, comprising:
a tube that at least partially defines a material channel, wherein the material channel is configured to guide a molten material; and
a nozzle coupled to the tube and configured to receive the molten material from the material channel and to rotate, wherein the nozzle includes a plurality of holes that are each configured to emit the molten material.

2. The device of claim 1, wherein the plurality of holes are configured to each emit a thread of the molten material.

3. The device of claim 1, further comprising a pressure element disposed in the tube and configured to pressurize the molten material in the material channel such that a pressure of the molten material at the nozzle is increased.

4. The device of claim 3, wherein the pressure element includes a screw disposed in the material channel and configured such that rotation with respect to the screw and the material channel pressurizes the molten material in the material channel.

5. The device of claim 4, wherein the screw includes a screw step that is configured to decrease along a length of the screw in a direction towards the nozzle.

6. The device of claim 3, wherein the pressure element includes a pressure pump.

7. The device of claim 1, further comprising a heat element coupled to the tube and configured to heat the molten material in the material channel to a target temperature, wherein the target temperature of the molten material is based on one or more of a printing speed, a pressure of the molten material at the nozzle, and a target viscosity of the molten material upon emission from the plurality of holes.

8. The device of claim 1, wherein the nozzle is configured to rotate in a manner such that threads of molten material emitted from the plurality holes are wrapped into a single thread.

9. The device of claim 1, further comprising a bearing coupled to the nozzle and the tube, wherein the nozzle is configured to rotate about the tube via the bearing.

10. The device of claim 1, wherein the nozzle includes a gear element and the device further comprises:
a gear coupled to the gear element such that rotation of the gear rotates the gear element and the nozzle; and
a motor coupled to the gear and configured to rotate the gear.

11. The device of claim 1, further comprising a hole adjustment mechanism coupled to the nozzle and configured to adjust a size of one or more of the plurality of holes.

12. A method, comprising:
guiding a molten material through a material channel toward a nozzle;
emitting the molten material through a plurality of holes of the nozzle; and
rotating the nozzle during emission of the molten material through the plurality of holes.

13. The method of claim 12, wherein emitting the molten material includes emitting the molten material as a thread from each of the plurality of holes.

14. The method of claim 12, further comprising pressurizing the molten material in the material channel.

15. The method of claim 14, wherein pressurizing the molten material includes pressurizing the molten material to a pressure that is based on one or more of a printing speed, a target temperature of the molten material, and a target viscosity of the molten material, and type of material.

16. The method of claim 14, wherein pressurizing the molten material includes performing a rotation with respect to a screw disposed inside of the material channel.

17. The method of claim 12, further comprising heating the molten material to a target temperature, wherein the target temperature of the molten material is based on one or more of a printing speed, a pressure of the molten material at the nozzle, and a target viscosity of the molten material upon emission from the plurality of holes.

18. A device, comprising:
a tube that at least partially defines a material channel, wherein the material channel is configured to guide a molten material;
a heat element coupled to the tube and configured to heat the molten material in the material channel to a target temperature;
a screw disposed in the material channel and configured such that rotation with respect to the screw pressurizes the molten material in the material channel; and
a nozzle coupled to the tube and configured to receive the pressurized molten material, wherein the nozzle is configured to rotate and includes a plurality of holes that are each configured to receive the pressurized molten material and to emit the pressurized molten material.

19. The device of claim 18, wherein the screw is coupled to the nozzle and is configured to rotate based on rotation of the nozzle.

20. The device of claim 18, further comprising a pin coupled to the nozzle and configured to rotate based on rotation of the nozzle, wherein the pin is disposed in a hole that goes through the screw and the screw is coupled to an inside wall of the tube such that the pin rotates with respect to the screw.

21. The device of claim 18, wherein a speed of the rotation with respect to the screw is based on a printing speed.

22. A three-dimensional (3D) printer nozzle, comprising:
a receive portion configured to receive a molten material from a material channel;
an emission end opposite the receive portion, wherein the emission end includes a plurality of holes that are each configured to receive the molten material and to emit the molten material; and
a rotation mechanism coupled to the emission end and configured to enable rotation of the nozzle about a tube, wherein the tube at least partially defines the material channel.

23. The 3D printer nozzle of claim 22, further comprising a screw coupled to the receive portion such that the screw is configured to rotate along with rotation of the nozzle, wherein the screw is further configured to be disposed in the material channel and to pressurize the molten material in the material channel in response to rotation of the screw.

24. The 3D printer nozzle of claim 22, further comprising a pin coupled to the receive portion such that the pin is configured to rotate along with rotation of the nozzle, wherein the pin is further configured to be disposed in a hole of a screw that is coupled to an inside wall of the tube.

25. The 3D printer nozzle of claim 22, wherein the rotation mechanism is configured to receive a ball bearing that is configured to be disposed between the rotation mechanism and the tube.

26. The 3D printer nozzle of claim 22, wherein the rotation mechanism includes a gear element configured to be coupled to a gear that is configured to be driven by a motor.

27. The 3D printer nozzle of claim 22, further comprising a hole adjustment mechanism coupled to the emission end and configured to adjust a size of one or more of the plurality of holes.
